(19) United States
(12) Patent Application Publication
(10) Pub. No.: US 2025/0173191 A1
(43) Pub. Date: May 29, 2025

(54) MEMORY ALLOCATION METHOD AND MEMORY ALLOCATION DEVICE USING UNIFIED MEMORY IN A MULTITENANT GPU ENVIRONMENT

(71) Applicant: Research & Business Foundation Sungkyunkwan University, Suwon-si (KR)

(72) Inventors: Hwansoo HAN, Suwon-si (KR); Jeongjae KIM, Suwon-si (KR); Yunchae CHOI, Suwon-si (KR)

(73) Assignee: Research & Business Foundation Sungkyunkwan University, Suwon-si (KR)

(21) Appl. No.: 18/957,104

(22) Filed: Nov. 22, 2024

(30) Foreign Application Priority Data
Nov. 24, 2023 (KR) 10-2023-0165761
Nov. 14, 2024 (KR) 10-2024-0161749

(51) Int. Cl. G06F 9/50

(52) U.S. Cl. CPC G06F 9/5038; G06F 9/5022

(57) ABSTRACT

Provided is a memory allocation/deallocation method for improving utilization and throughput of GPU, and a method for allocating a memory using a unified memory according to an embodiment may include: checking whether a kernel of an executed task is terminated; checking whether there is a variable in which the use of the memory is finished after completing kernel execution among variables used as a kernel factor of the executed task; deallocating, when there is the variable in which the use of the memory is finished, the corresponding variable; calculating the deallocated memory amount; and transmitting the deallocated memory amount to a scheduler.

### CROSS REFERENCE TO RELATED APPLICATIONS

This application claims the benefit under 35 USC § 119(a) of Korean Patent Application No. 10-2023-0165761, filed on Nov. 24, 2023, Korean Patent Application No. 10-2024-0161749, filed on Nov. 14, 2024, the entire disclosure of which is incorporated herein by reference for all purpose.

### TECHNICAL FIELD

The present disclosure relates to wireless communication and, more particularly, to a method and apparatus for coordinating inter-cell interference in a wireless communication system.

### BACKGROUND

A graphic processing unit (GPU) is widely used in various fields based on a high parallel processing capability. However, since it is difficult for a single tenant or task to use a lot of computing resources and memory resources of the GPU, multitenants share and use the GPU recently.

Since general programmers perform programming by assuming that the GPU is used alone, Out-of-Memory Error can potentially occur in a multitenant GPU when the multitenant GPU does not manage the amount of memory for each tenant. This can cause abnormal termination of a GPU application program, which can be a fatal problem. Therefore, the prior work proposes a scheduling for preventing an Out-of-Memory Error by considering the required amount of memory of a task and the amount of extra memory of the GPU.

However, programmers practically create a program to deallocate all memory just before the program is terminated. In this case, tasks unnecessarily occupy a memory, so an opportunity to schedule other tasks is actually missed. In addition, even if the required memory of the task is slightly larger than a current extra memory amount of the GPU, the task is not scheduled and a long pending time is suffered, and the remaining GPU resources are not used but wasted.

### SUMMARY

The present disclosure provides a method or a device which does not deallocate, when a plurality of tasks use memory, a used memory just before the finishing of the task, but may deallocate the memory by finding variables which unnecessarily occupy the memory even though the use is finished among variables of a task which is being executed.

Further, the present disclosure provides a method or a device which may enhance a utilization and a throughput of a GPU by using a unified memory which may be used by exceeding a GPU total memory amount.

In an aspect, provided is a memory for allocating a memory using a unified memory which may include: checking whether a kernel of an executed task is terminated; checking whether there is a variable in which the use of the memory is finished after completing kernel execution among variables used as a kernel factor of the executed task; deallocating, when there is the variable in which the use of the memory is finished, the corresponding variable; calculating the deallocated memory amount; and transmitting the deallocated memory amount to a scheduler.

Further, the checking of whether there is the variable in which the use of the memory is finished may be checking whether the use of the memory is finished for each variable by using a compiler.

In addition, the method may further include, after the transmitting, comparing an extra memory amount of the GPU and a required memory amount of a pending task, and scheduling the pending task to the GPU.

Furthermore, when there is no variable in which the use of the memory is finished, the process may proceed to the comparing of the extra memory amount of the GPU and the required memory amount of the pending task, and scheduling the pending task to the GPU.

In addition, the method may further include checking whether the executed task is executed in the extra memory when the kernel of the executed task is not terminated.

Further, the method may further include checking whether a task having a higher priority than the executed task is terminated when the executed task is executed the extra memory.

Further, the method may further include allocating an additional memory when the higher-priority task is terminated.

In addition, the process may return to the checking of whether the kernel of the executed task is terminated when the executed task is not executed in the extra memory, or the higher-priority is not terminated.

In another aspect, provided are one or more non-transitory computer-readable media storing one or more instructions, in which the one or more instructions executed by one or more processors may be configured to check whether a kernel of an executed task is terminated, check whether there is a variable in which the use of the memory is finished after completing kernel execution among variables used as a kernel factor of the executed task, deallocate, when there is the variable in which the use of the memory is finished, the corresponding variable; calculate the deallocated memory amount, and transmit the deallocated memory amount to a scheduler.

In yet another aspect, provided is a device for allocating a memory using a unified memory which may include: a memory configured to store a plurality of instructions; and a processor functionally connected to the memory, in which the processor may be configured to, when the plurality of instructions are executed, check whether a kernel of an executed task is terminated, check whether there is a variable in which the use of the memory is finished after completing kernel execution among variables used as a kernel factor of the executed task, deallocate, when there is the variable in which the use of the memory is finished, the corresponding variable; calculate the deallocated memory amount, and transmit the deallocated memory amount to a scheduler.

Further, the processor may be configured to check whether there is the variable in which the use of the memory is finished by detecting whether the use of the memory is finished for each variable by using a compiler.

In addition, after transmitting the deallocated memory amount to the scheduler, the processor may be configured to compare an extra memory amount of the GPU and a required memory amount of a pending task, and schedule the pending task to GPU.

Further, when there is no variable in which the use of the memory is finished, the processor may be configured to comparing the extra memory amount of the GPU and the required memory amount of the pending task, and schedule the pending task to the GPU.

In addition, the processor may be configured to check whether the executed task is executed in the extra memory when the kernel of the executed task is not terminated.

Further, the processor may be configured to check whether a task having a higher priority than the executed task is terminated when the executed task is executed the extra memory.

In addition, the processor may be configured to allocate an additional memory when the higher-priority task is terminated.

Further, processor may be configured to check whether the kernel of the executed task is terminated again when the executed task is not executed in the extra memory, or the higher-priority is not terminated.

According to an embodiment, a time when memory resources are secured can be advanced from a termination time of a program to a use termination time of each variable, so a task which is not scheduled due to a shortage of a GPU free memory amount can be found and scheduled in the GPU.

Further, according to an embodiment, by using a unified memory, even when a required memory amount of a task is larger than the GPU free memory amount, the corresponding task can be scheduled to the GPU, a task processing time can be enhanced.

### BRIEF DESCRIPTION OF THE DRAWINGS

FIG. 1 illustrates a code representing memory allocation and deallocation according to the existing method.

FIGS. 2 and 3 are flowcharts illustrating memory allocation and deallocation according to an embodiment.

FIG. 4 illustrates a code representing a method for deallocating a memory for each variable according to an embodiment.

FIGS. 5A and 5B illustrate codes representing a memory allocation method using a unified memory.

FIGS. 6A and 6B illustrate codes representing a method for monitoring whether an executed task an Eager Launch task and whether a task having a higher priority than the executed task is terminated.

FIGS. 7 and 8 are diagrams for describing a process of scheduling a task through a part serving as a scheduler and a part serving as a task of a processor according to an embodiment.

FIG. 9 is a graph illustrating a task processing time in each of the memory allocation method according to an embodiment and the existing memory allocation method.

FIG. 10 is a graph for describing a cause of occurrence of a difference in task processing time between the memory allocation method according to an embodiment and the existing memory allocation method.

FIG. 11 is a graph illustrating a task processing time in each of the memory allocation method according to an embodiment and the existing memory allocation method.

FIG. 12A and 12B are graphs illustrating task-specific processing times in the memory allocation method according to an embodiment and the existing memory allocation method.

FIG. 13 is a block diagram of a memory allocation device according to an embodiment.

### DETAILED DESCRIPTION

In describing embodiments of the present disclosure, a detailed description of the known art related with the present disclosure will be omitted when it is judged that the detailed description may unnecessarily make the gist of the present invention unclear. In addition, terms to be described below as terms which are defined in consideration of functions in the present disclosure may vary depending on the intention of a user or an operator or usual practice. Accordingly, the terms need to be defined based on contents throughout the present disclosure. Terms used in a detailed description are to just describe the embodiments of the present disclosure and should not be restrictive in any way. Unless specifically used otherwise, expression of a singular form includes a meaning of a plural form. In the description, an expression such as “including” or “comprising” is intended to indicate certain features, numbers, steps, operations, elements, some or combinations thereof and should not be construed to preclude the presence or possibility of one or more other features, numbers, steps, operations, elements, some or combinations thereof in addition to the described things.

Terms including an ordinary number, such as “first” and “second”, are used for describing various components, but the components are not limited by the terms. The terms may be used as a denominative meaning for distinguishing one component from another component, and a sequential meaning between the components is determined through a context of the description, not such a name.

The term “and/or” is used to include all cases of any combination of a plurality of items that are subject to the target. For example, “A and/or B” is a meaning including all of three cases, “A”, “B” and “A and B”.

It should be understood that, when it is described that a component is “connected to” or “accesses” another component, the component may be directly connected to or access the other component or a third component may be present therebetween.

Hereinafter, a specific embodiment of the present disclosure will be described with reference to the accompanying drawings. The following detailed description is provided to assist comprehensive understanding of a method, a device, and/or an object described in the present disclosure. However, this is just an example and the present disclosure is not limited thereto.

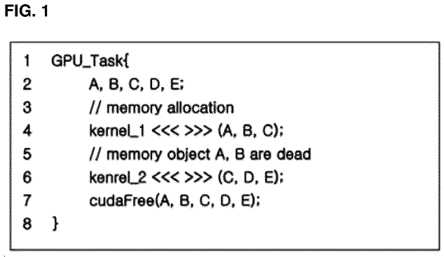

FIG. 1 illustrates a code representing memory allocation and deallocation according to the existing method.

In general, in memory allocation for task processing, a programmer uses a GPU pinned memory allocation method, and performs programming by assuming that a GPU is used alone.

Therefore, since a multi-task GPU does not manage a memory amount used for each task, an Out-of-Memory Error may occur potentially. The Out-of-Memory Error is a fatal problem which may cause abnormal termination of a GPU application program. CASE which is the prior work proposes a scheduling for preventing the Out-of-Memory Error by considering a required memory amount of a task and a GPU free memory amount.

However, programmers practically create a program to deallocate all memory just before the program is terminated as illustrated in FIG. 1. Tasks unnecessarily occupy used memory, so an opportunity to schedule other tasks is actually missed. In addition, even if the required memory of the task is slightly larger than a current GPU free memory amount, the task is not scheduled causing long pending time and remaining GPU resources are not used. Even in this case, the task is not scheduled due to a small amount of difference, so there is a problem in that GPU resources are wasted.

According to an embodiment, a method may be provided, which does not deallocate a used memory just before the finishing of the task, but may deallocate the memory by finding variables which unnecessarily occupy the memory even though the use is terminated among variables of a task which is being executed.

Further, according to an embodiment, a method may be provided required, which may enhance a utilization and a throughput of a GPU by not using the GPU alone, but using a unified memory which may be used by exceeding a GPU total memory amount.

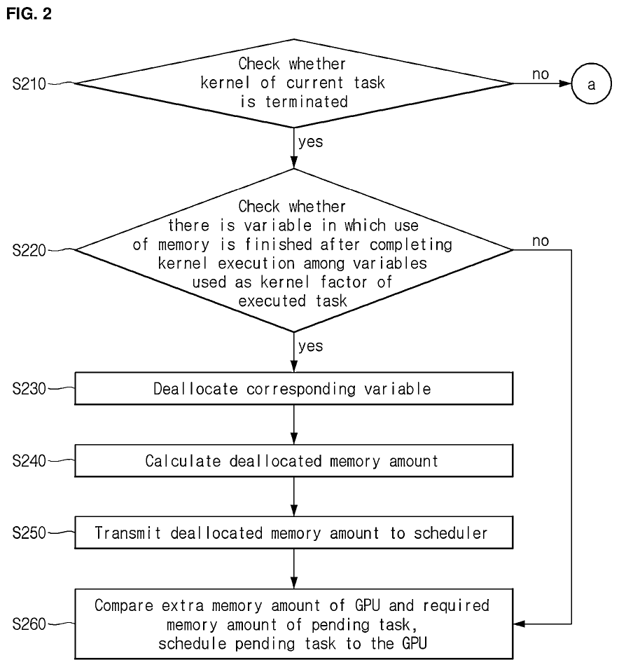

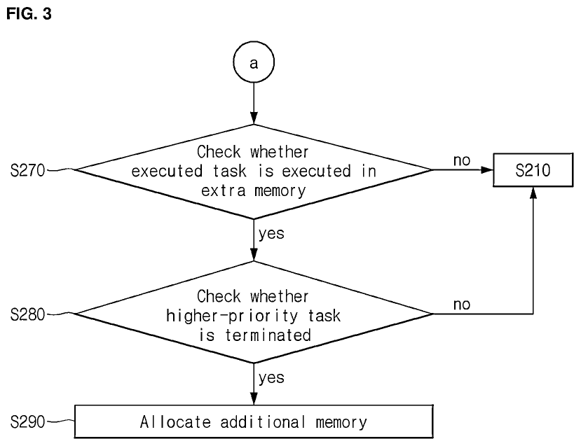

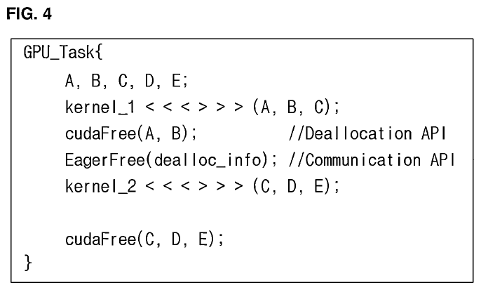

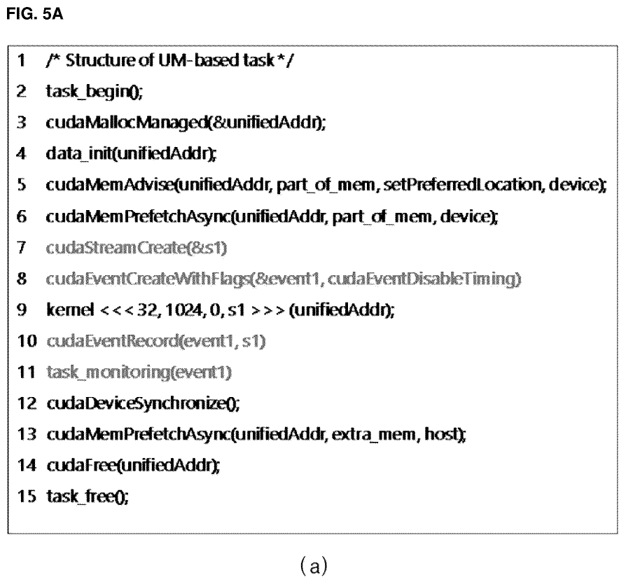

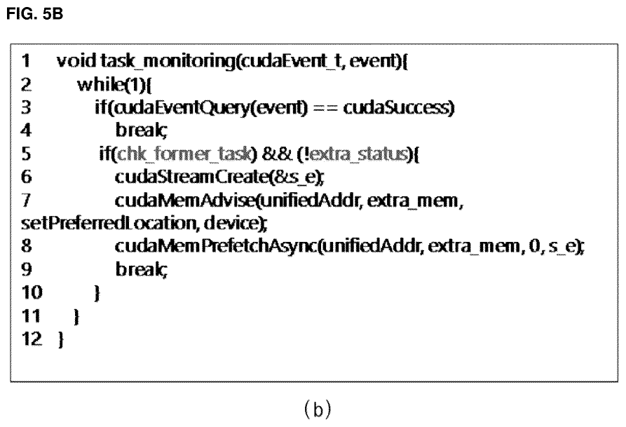

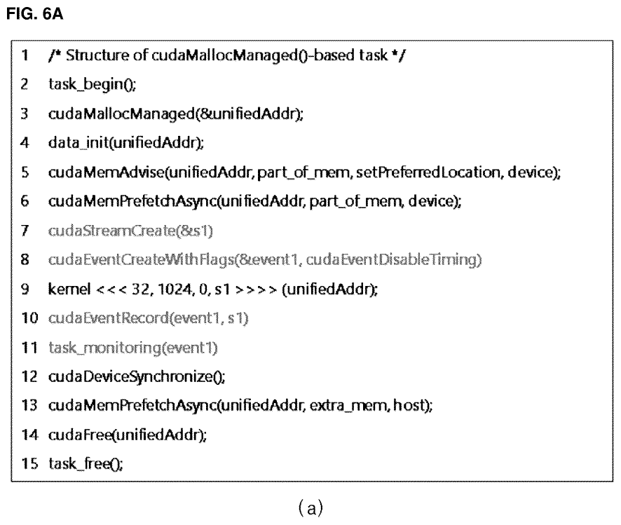

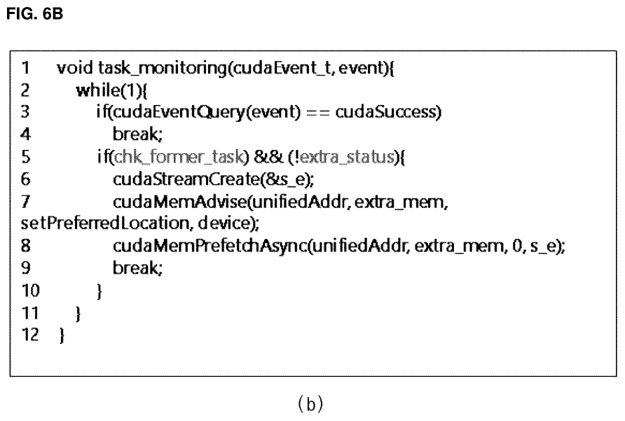

FIGS. 2 and 3 are flowcharts illustrating memory allocation and deallocation according to an embodiment. FIG. 4 illustrates a code representing a method for deallocating a memory for each variable according to an embodiment. FIGS. 5A and 5B illustrate codes representing a memory allocation method using a unified memory. FIGS. 6A and 6B illustrate codes representing a method for monitoring whether an executed task an Eager Launch task and whether a task having a higher priority than the executed task is terminated.

A subject of the memory allocation method according to the embodiment illustrated in FIGS. 2 and 3 is not limited, but it is described as an example that the memory allocation method is executed by a processor. The processor according to the embodiment may manage a memory by inputting a predetermined code into a scheduler. A part of the processor may serve as the scheduler. Further, the other part of the processor may serve as the task.

Referring to FIG. 2, the memory allocation method according to the embodiment may be performed by the unified memory.

The memory allocation method may include a step S210 of checking whether a kernel of an executed task is terminated, a step S220 of checking whether there is a variable in which the use of memory is finished after completing kernel execution among variables used as a kernel factor of the executed task, a step S230 of deallocating, when there is the variable in which the use of the memory is finished, the corresponding variable, a step S240 of calculating the deallocated memory amount, and a step S250 of transmitting the deallocated memory amount to a scheduler.

The step S210 of checking whether the kernel of the executed task is terminated is a step of checking whether a kernel of a task which a processor currently executes in the memory is terminated.

The step S220 of checking whether there is a variable in which the use of memory is finished after completing kernel execution among variables used as a kernel factor of the executed task is a step of checking whether there is a variable of which use is finished among variables (e.g., A and B) used as the kernel factor of the task.

According to an embodiment, the processor may know how many kernels are passed until the use of each variable is finished by using def-use chain technology of a compiler with respect to whether the memory use is finished for each variable by using the compiler, and accordingly may execute Eager Free at a time when the use is finished.

The step S230 of deallocating, when there is the variable in which the use of the memory is finished, the corresponding variable is a step in which when the processor determines that there is the variable in which the use of the memory is finished among the respective variables, the processor executes a cudaFree (A, B) illustrated in FIG. 4 for deallocating A and B from memory, and deliver information on the deallocation by executing an EagerFree (dealloc_info) code.

Steps S240 and S250 are steps in which the processor calculates the deallocated memory amounts (e.g., memory amounts occupied by A and B), and transmits the deallocated memory amounts to the scheduler.

The scheduler may obtain the deallocated memory amounts, and compare the free memory amount of the GPU and a required memory amount of a pending task, and allocate the pending task to the memory (S260).

The memory deallocation method may be named EagerFree. The Eager Free may include a process in which the memory allocation device determines a time when the use of GPU memory variables is finished, and deallocates the memory at the corresponding time, that is, a process of immediately deallocating the used memory in the task.

The memory allocation method in FIGS. 2 and 3 may be performed by a unified memory (UM).

Referring to FIG. 3, in the memory allocation method according to the embodiment, when the processor determines that the kernel of the task currently executed in the memory is not terminated in step S210, the processor may advance an algorithm to a step S270 of checking whether the executed task is executed in an extra memory.

Further, when the processor determines that the executed task is executed in the extra memory in step S270, the processor may advance the algorithm to a step S280 of checking whether the kernel of the task having the higher priority than the currently executed task is terminated.

When the processor determines that the executed task is not executed in the extra memory or determines that the kernel of the task having the higher priority than the currently executed task is not terminated in steps S270 and S280, the processor may return to the step S210 of checking whether the kernel of the currently executed task is terminated.

When the processor determines that the task having the higher priority than the currently executed task is terminated in step S280, the processor may be allocated with an additional memory from the unified memory (step S290).

The memory allocation method using the unified memory in FIG. 3 may be named EagerLaunch. The Eager Launch may include a process in which the memory allocation device compares an available memory amount of the GPU and a required memory amount of a task to be executed, and grants an execution priority, and additionally allocates the memory to an Eager Launch task preferentially when the available memory is added to a GPU device to schedule a task in which the required memory amount is larger than the available memory amount.

The memory allocation method using the unified memory in FIG. 3 may be referenced by the code FIG. 5a and the code of FIG. 5B, and the code of FIG. 6A and the code of FIG. 6. Referring to FIG. 5A, in the existing task code, a page may be pinned to a device memory by a GPU memory allocation scheme by calling cudaMalloc() API. Thereafter, data is transferred to a device by using cudaMemcpy() and the kernel accesses to the device to use the data. When only cudaMallocManaged() API is used, a memory used in a demand paging form is allocated upon accessing between a CPU and the GPU, and the memory is used in a different form from a memory allocated to cudaMalloc() API, and an operation is performed. However, when a flag setPreferredLocation is set to the device, and called in cudaMemAdvise() API by the same scheme as FIG. 5B, the page is pinned to the device to access the memory similar to the case of using cudaMalloc() API. Further, when cudaMemcpy () used for data transfer is replaced with cudaMemPrefetchAsync() all task codes operate to the case of using the memory pinned to the device.

When the task is executed by using excessive use of the memory by securing only some memory, another task is terminated, and when the memory is returned, the memory should be additionally secured an Eager Launch task earlier than the task which is pended currently. In order to perform such a task, two following steps are executed by additionally inserting the API in the middle of a task code. First, it should be checked whether the kernel in the task is terminated. The kernel which is executed by allocating only some memory may be terminated before the prior high-priority task is terminated. In this case, even though the kernel is terminated, whether the task i.e., the high-priority task is terminated may be unnecessarily pended, so it should be continuously checked whether the kernel is terminated. Whether the kernel is terminated may be checked through a query by using cudaEvent in the same scheme as FIG. 6A and FIG. 6B. Second, it is checked whether the task, i.e., the high-priority task is terminated. The scheduler communicates with the task through the shared memory. Accordingly, a total of two types, a variable for checking whether the task is terminated in a data structure of the scheduler in the related art, and a variable related to a memory amount which the scheduler is to allocate to the Eager Launch task are added. When it is checked whether the task is terminated during execution of a kernel of the Eager Launch task, and the memory is additionally secured, a page may be additionally pinned and data may be transferred by calling cudaMemAdvise() API and cudaMemPrefetch() API in a stream apart from a stream in which the kernel is executed.

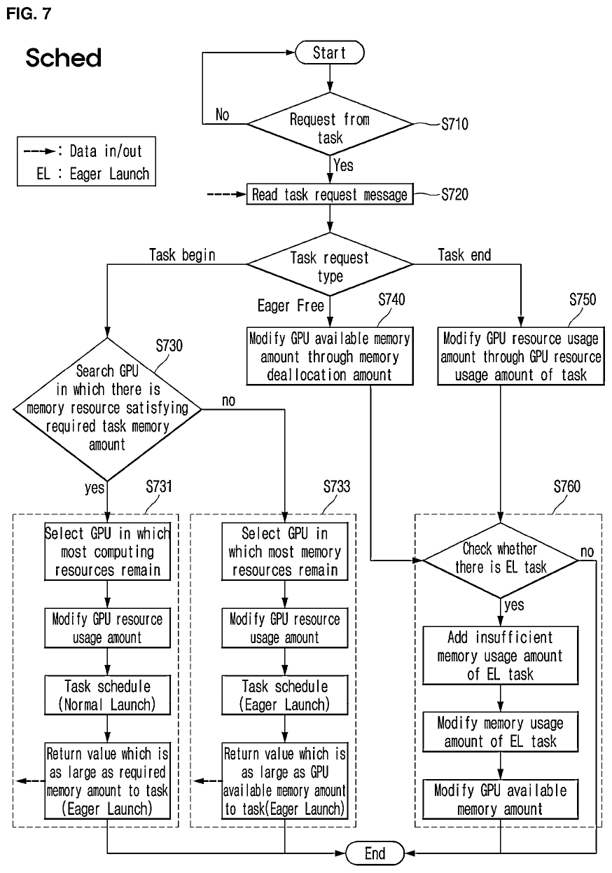

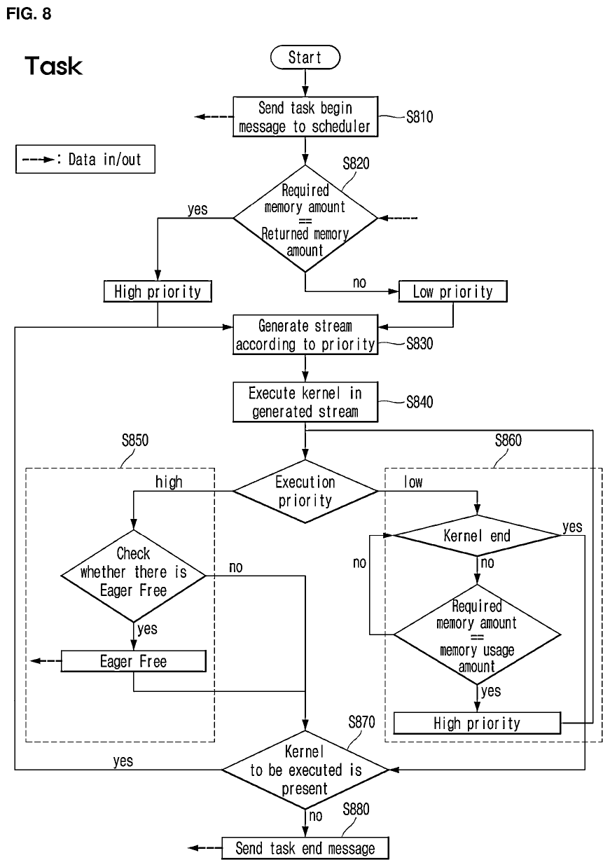

FIGS. 7 and 8 are diagrams for describing a process of scheduling a task through a part serving as a scheduler and a part serving as a task of a processor according to an embodiment.

According to the embodiment of the present disclosure, the processor of the memory allocation device may include a part that serves as a scheduler (part ‘Sched’ of FIG. 7) and a part that serves as a task (part ‘Task’ of FIG. 8).

Referring to FIG. 7, in steps S710 and S720, the scheduler of the memory allocation device may receive a task request message from the part that serves as the task, and read the received task request message. At this time, the scheduler may know the type of task request message through the task request message, and the task request message type may be either ‘Task Start’, ‘Eager Free’, and ‘Task End’.

When the task request message type is ‘Task Start’, the scheduler may search a GPU with a memory resource which satisfies a required task memory amount in step S730.

When there is the GPU with the memory resource which satisfies the required task memory amount, the scheduler may select a GPU in which most computing resources remain, modify a GPU resource usage amount, schedule the task as ‘Normal Launch task’, and return a value which is as large as the required memory amount to the part serving as the task as a ‘memory return amount’, in step S731. At this time, the scheduler may return the memory return amount to the part serving as the task, and then return to step S710 again, and repeat an entire process.

When there is no GPU with the memory resource which satisfies the required task memory amount, the scheduler may select a GPU in which most memory resources remain, modify a GPU resource usage amount, schedule the task as ‘Eager Launch task’, and return a value which is as large as a GPU available memory amount to the part serving as the task as the ‘memory return amount’, in step S733. At this time, the scheduler may return the memory return amount to the part serving as the task, and then return to step S710 again, and repeat the entire process.

When the task request message type is ‘Eager Free’, the scheduler may modify the available memory amount of the GPU through a memory deallocation amount in step S740. At this time, the memory deallocation amount indicates an amount in which the memory is deallocated immediately through Eager Free. Thereafter, in step S760, the scheduler checks whether there is the Eager Launch task is present, and when the Eager Launch task is present, additionally allocates a memory which is as large as a memory usage amount which is insufficient to execute the Eager Launch task, and modifies the memory usage amount of the Eager Launch task, thereby modifying the GPU available memory amount. At this time, the scheduler may return to step S710 and repeatedly perform the entire process after completing modification of the GPU available memory amount or when there is no Eager Launch task.

When the task request message type is ‘Task End’, the scheduler may terminate the corresponding task, and modify the GPU resource usage amount through the GPU resource usage amount of the terminated task in step S750. Thereafter, in step S760, the scheduler checks whether there is the Eager Launch task is present, and when the Eager Launch task is present, additionally allocates a memory which is as large as a memory usage amount which is insufficient to execute the Eager Launch task, and modifies the memory usage amount of the Eager Launch task, thereby modifying the GPU available memory amount. At this time, the scheduler may return to step S710 and repeatedly perform the entire process after completing modification of the GPU available memory amount or when there is no Eager Launch task.

Referring to FIG. 8, in step S810, the part serving the task may deliver the ‘Task Start’ message to the scheduler as the task request message.

In step S820, the part serving as the task may be returned with a memory return amount from the scheduler, compare a required memory amount of a task to be executed and the memory return amount, and designate the task as a high priority when the required memory amount is equal to or less than the memory return amount, and designate the task as a low priority when the required memory amount is more than the memory return amount.

In step S830, the part serving as the task may generate a stream according to a priority.

In step S840, the part serving as the task may execute a kernel in the generated stream.

In the case of the task having the high priority, in step S850, the part serving as the task may check whether the task Eager Free and deliver ‘Eager Free’ to the scheduler as the task request message when the task is Eager Free. Thereafter, in step S870, the part serving as the task may check whether there is the kernel to be executed. Thereafter, when the task is not Eager Free, the part serving as the task may immediately check whether there is the kernel to be executed in step S870.

In the case of the task having the low priority, in step S860, the part serving as the task may check whether the kernel is terminated, and adjust the priority by comparing the required memory amount of the task and a current required memory amount of the GPU when the kernel is not terminated. At this time, the part serving as the task may adjust the task as the high priority when the required memory amount of the task is equal to or less than the memory usage amount, and the task adjusted as the high priority is performed through the same step as the task having the high priority, i.e., step S850. When the required memory amount of the task is more than the memory usage amount, the part serving as the task may return to a step of checking whether the kernel is terminated again. When the kernel is terminated, the part serving as the task may check whether there is the kernel to be executed in step S870.

In step S870, the part serving as the task may return to step S830 of generating the stream according to the priority again, and repeat the step by executing the kernel in the generated stream, when there is the kernel to be executed.

When there is no kernel to be executed, the part serving the task may deliver the ‘Task End’ to the scheduler as the task request message in step S880.

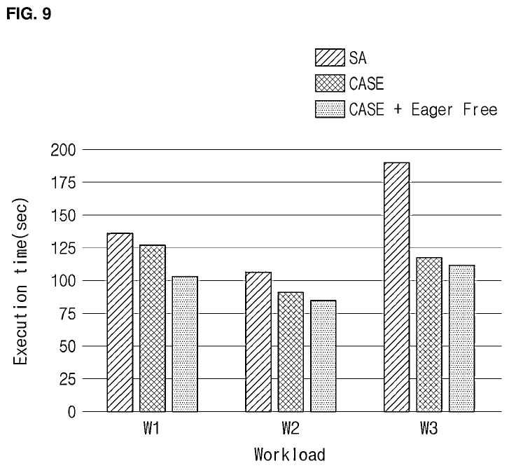

FIG. 9 is a graph illustrating a task processing time in each of the memory allocation method according to an embodiment and the existing memory allocation method.

An execution time of each application and an execution time of all workloads are measured by performing three types of workloads. Each workload is configured as follows. In order to compare a performance of Eager free, a technique (single assignment (SA)) which executes only one task simultaneously with one GPU, and a technique (CASE) which simultaneously schedules tasks as many as possible if an extra memory amount of the GPU is sufficient are used. By three methods, workloads are executed, and execution results are compared and analyzed. FIG. 9 is a graph in which in order to compare three methods, a total of three workloads are executed by respective methods, and execution completion times are compared. Referring to W2, the execution completion time is 107.06 seconds when SA is used, 91.18 seconds when CASE is used, and 84.51 seconds when Eager Free is used, so it may be confirmed that the execution completion time is longest in SA. The reason is that tasks are not simultaneously scheduled, so each task is not scheduled and a pending time is longest in SA. By comparing with SA, when CASE and Eager Free are used, execution of the workloads is completed by 14.83% and 21.06%, respectively. This shows a fact that simultaneous schedule of the task helps to enhancement of a throughput of the system. By comparing with Case, when Eager Free is used, the execution completion time of the workload is reduced by approximately 7.32%. When Eager Free is used, more tasks may be simultaneously scheduled, so the pending time of the task is reduced.

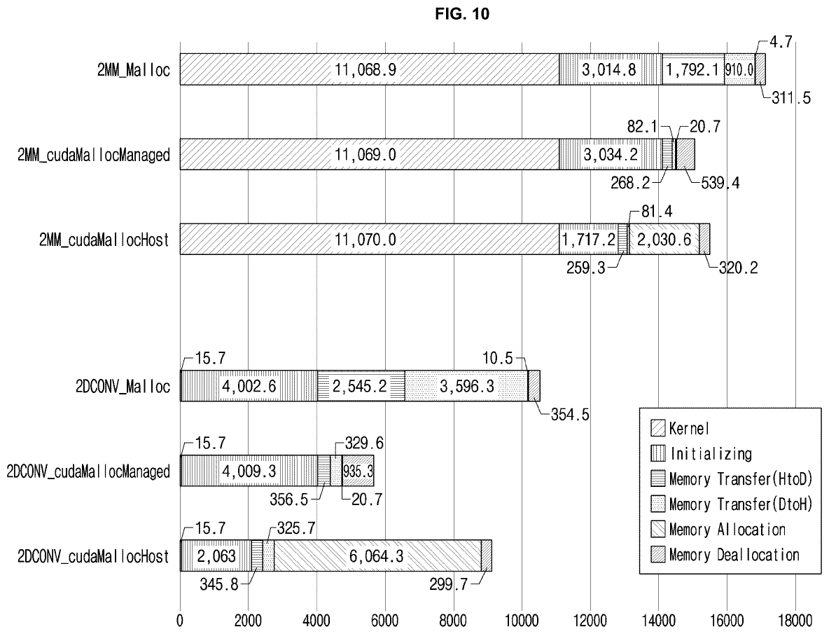

FIG. 10 is a graph for describing a cause of occurrence of a difference in task processing time between the memory allocation method according to an embodiment and the existing memory allocation method.

Even in a unified memory based task, since the memory is pinned to the device through cudaMemAdvise() when the kernel accesses the memory, the same time as the GPU fixed memory based task. As can be seen from a Kernel area of FIG. 10, it can be seen that 11,069 milliseconds in 2 MM and 15.7 milliseconds in 2DCONV are consumed similarly. There is also an advantage in an overall consumed time, the reason is that there is a phenomenon in which when data is copied from an area allocated to Malloc to an area allocated to cudaMalloc() the data is copied once from a pageable page at a host side to a pinned page at the host side, and transferred to the device. Therefore, when the pinned page is allocated to the host by using cudaMallocHost() rather than allocating the page to the host by malloc() the same data transfer time as cudaMallocManaged occurs. This can also be known from MemoryTransfer (HtoD) and Memory Transfer (DtoH) parts in FIG. 10. Compared to a case where in the GPU pinned memory based task, a data transfer time when data is transferred to the device and a data transfer time when data is transferred to the host in 2 MM are generated as 1792.1 and 910.0 milliseconds, respectively and 2,542.2 and 3,596.3 milliseconds are generated in 2DCONV, in the unified memory based task and the GPU pinned memory based task using cudaMallocHost() 260 and 82 milliseconds are consumed when executing 2 MM and 250 and 325 milliseconds are consumed when executing 2DCONV, respectively. An Eager Launch performance evaluation is also performed by comparing with performances of SA and CASE scheduling technique. Workloads used for performance comparison are constituted by 5 2 MM applications and 5 3 MM applications, and all applications operate based on the unified memory.

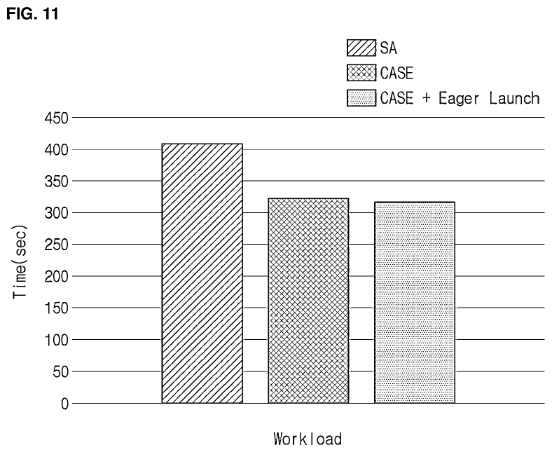

FIG. 11 is a graph an execution completion time of a corresponding workload for each scheduling policy. As can be seen from the graph, it can be seen that the execution completion time of the workload decreases in the order of SA, CASE, and Eager Launch, which may require 409 seconds, 324 seconds, and 318 seconds, respectively.

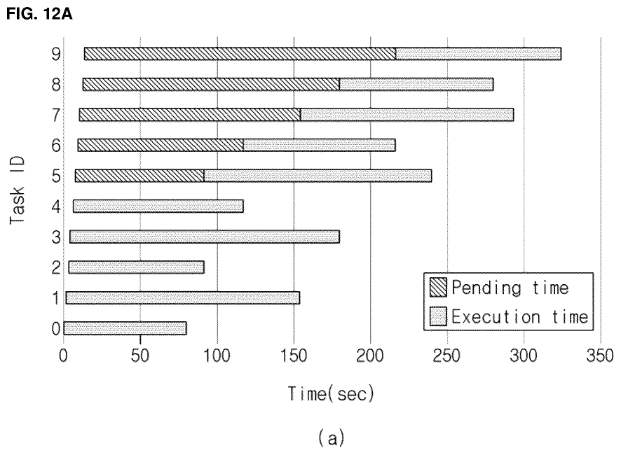

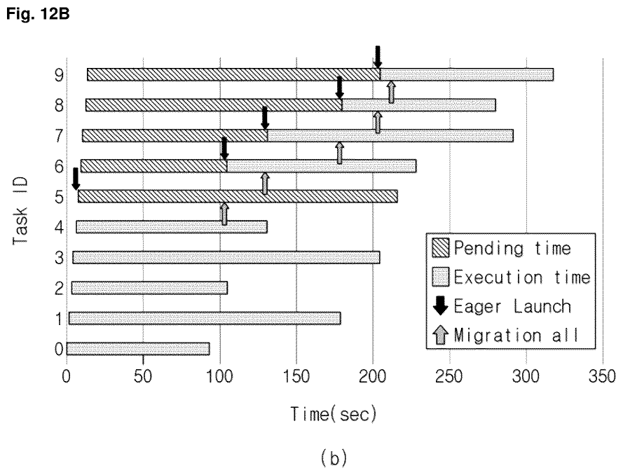

FIG. 12A and 12B are graphs illustrating task-specific processing times in the memory allocation method according to an embodiment and the existing memory allocation method.

In FIGS. 12A and 12B, an even-numbered Task ID represents a 2 MM application, and an odd-numbered Task ID represents a 3 MM application. A hatched portion means a time when the task requests the schedule, but a current extra memory is insufficient, or there is already a task which is subject to Eager Launch, and the task is not scheduled, but is pended. In FIG. 12B, a ‘Eager Launch’ arrow means a time when the task is subject to Eager Launch, and a ‘Migration all’ arrow means a time when the task which is subject to Eager Launch secures all memories. When comparing with FIG. 12A, in FIG. 12B, it can be seen that the time when the task is scheduled according to Eager Launch is advanced, and as a result, a total workload execution completion time is reduced. As the number of tasks simultaneously scheduled to one GPU through Eager Launch increases, tasks sharing computing resources become more, and as a result, the execution time of each task increases. However, it can be seen that more tasks are executed at once while the memory resources of the GPU are maximally used, and as a result, an execution time of an entire taskset is reduced by 22.3% compared to SA and 1.9% compared to CASE.

In an embodiment, first, proposed is Eager Free which immediately deallocates a variable of which use is finished in a CUDA application when scheduling the task. Immediately after the use of the variable is finished, the variable is deallocated, which allows the task to allocate and maintain only a memory actually required, thereby securing the extra memory of the GPU. Second, proposed is Eager Launch in which application of only some memories is scheduled and executed without an OOM error even in a situation in which a required memory of the task is larger than the current device extra memory by utilizing a memory over-subscription through the unified memory.

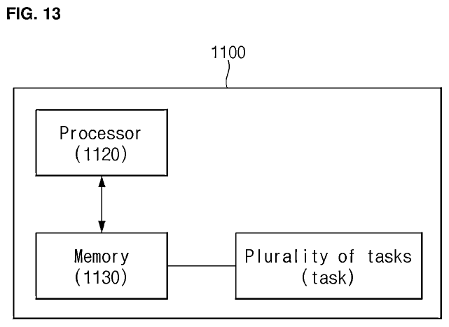

FIG. 13 is a block diagram of a memory allocation device according to an embodiment. FIG. 13 illustrates that the memory allocation method in FIGS. 2 and 3 are reconfigured from a perspective of hardware.

Referring to FIG. 13, the memory allocation device 1100 according to an embodiment may include a processor 1120, and a memory 1130 which performs a plurality of tasks. Further, the memory allocation device according to an embodiment may further include a unified memory for managing the memory 1130. The memory 1130 may be electrically connected with a GPU.

The processor 1120 may be set to check whether there is a variable in which the use of the memory is finished after completing kernel execution among variables used as a kernel factor of an executed task, deallocate the corresponding variable when there is the variable in which the use of the memory is finished, calculate the deallocated memory amount, and transmit the deallocated memory amount to a scheduler.

The embodiment of the present disclosure may be implemented by various means, e.g., hardware, firmware, software, or combinations thereof. In the case of implementation by hardware, an embodiment of the present disclosure may be implemented by using one or more application specific integrated circuits (ASICs), digital signal processors (DSPs), digital signal processing devices (DSPDs), programmable logic devices (PLDs), field programmable gate arrays (FPGAs), processors 1020, controllers, micro-controllers, microprocessors, and the like. In the case of implementation by firmware or software, an embodiment of the present disclosure may be implemented in the form of a module, a procedure, a function, and the like to perform the capability or operations described above. A software code may be stored in the memory 1130 and executed by the processor 1120. The memory 1130 may be positioned inside or outside the processor 1120 and may transmit and receive data to/from the processor 1120 by already various means.

Meanwhile, the embodiments of the present disclosure may be implemented as a computer readable code in a computer readable recording medium. The computer readable recording medium includes all kinds of recording devices storing data which may be deciphered by a computer system. Examples of the computer readable recording medium include a ROM, a RAM, a CD-ROM, a magnetic tape, a floppy disk, an optical data storage device, and the like. Further, the computer readable recording media may be stored and executed as codes which may be distributed in the computer system connected through a network and read by a computer in a distribution method. In addition, functional programs, codes, and code segments for implementing the embodiments may be easily inferred by programmers in technical field to which the present disclosure pertains.

The aforementioned description of the present disclosure is used for exemplification, and it can be understood by those skilled in the work that the present disclosure can be easily modified in other detailed forms without changing the technical spirit or requisite features of the present disclosure. Therefore, it should be appreciated that the aforementioned embodiments are illustrative in all aspects and are not restricted.

The scope of the present disclosure is represented by claims to be described below rather than the detailed description, and it is to be interpreted that the meaning and scope of the claims and all the changes or modified forms derived from the equivalents thereof come within the scope of the present disclosure.

What is claimed is:

1. A method for allocating a memory to a graphic processing unit (GPU) using a unified memory, the method comprising:
checking whether a kernel of an executed task is terminated;
checking whether there is a variable in which the use of the memory is finished after completing kernel execution among variables used as a kernel factor of the executed task;
deallocating, when there is the variable in which the use of the memory is finished, the corresponding variable;
calculating the deallocated memory amount; and
transmitting the deallocated memory amount to a scheduler.

2. The method of claim 1, wherein the checking of whether there is the variable in which the use of the memory is finished is checking whether the use of the memory is finished for each variable by using a compiler.

3. The method of claim 1, further comprising:
after the transmitting,
comparing an extra memory amount of the GPU and a required memory amount of a pending task, and scheduling the pending task to the GPU.

4. The method of claim 3, wherein when there is no variable in which the use of the memory is finished, the process proceeds to the comparing of the extra memory amount of the GPU and the required memory amount of the pending task, and scheduling the pending task to the GPU.

5. The method of claim 3, further comprising:
checking whether the executed task is executed in the extra memory when the kernel of the executed task is not terminated.

6. The method of claim 5, further comprising:
checking whether a task having a higher priority than the executed task is terminated when the executed task is executed the extra memory.

7. The method of claim 6, further comprising:
allocating an additional memory when the higher-priority task is terminated.

8. The method of claim 6, wherein the process returns to the checking of whether the kernel of the executed task is terminated when the executed task is not executed in the extra memory, or the higher-priority is not terminated.

9. One or more non-transitory computer-readable media storing one or more instructions, wherein the one or more instructions executed by one or more processors are configured to
check whether a kernel of an executed task is terminated,
check whether there is a variable in which the use of the memory is finished after completing kernel execution among variables used as a kernel factor of the executed task,
deallocate, when there is the variable in which the use of the memory is finished, the corresponding variable,
calculate the deallocated memory amount, and
transmit the deallocated memory amount to a scheduler.

10. A device for allocating a memory using a unified memory, the device comprising:
a memory configured to store a plurality of instructions; and
a processor functionally connected to the memory,
wherein the processor is configured to, when the plurality of instructions are executed,
check whether a kernel of an executed task is terminated,
check whether there is a variable in which the use of the memory is finished after completing kernel execution among variables used as a kernel factor of the executed task,
deallocate, when there is the variable in which the use of the memory is finished, the corresponding variable,
calculate the deallocated memory amount, and
transmit the deallocated memory amount to a scheduler.

11. The device of claim 10, wherein the processor is configured to check whether there is the variable in which the use of the memory is finished by detecting whether the use of the memory is finished for each variable by using a compiler.

12. The device of claim 10, wherein after transmitting the deallocated memory amount to the scheduler, the processor is configured to compare an extra memory amount of the GPU and a required memory amount of a pending task, and schedule the pending task to the GPU.

13. The device of claim 12, wherein when there is no variable in which the use of the memory is finished, the processor is configured to comparing the extra memory amount of the GPU and the required memory amount of the pending task, and schedule the pending task to the GPU.

14. The device of claim 12, wherein the processor is configured to check whether the executed task is executed in the extra memory when the kernel of the executed task is not terminated.

15. The device of claim 14, wherein the processor is configured to check whether a task having a higher priority than the executed task is terminated when the executed task is executed the extra memory.

16. The device of claim 15, wherein the processor is configured to allocate an additional memory when the higher-priority task is terminated.

17. The device of claim 15, wherein the processor is configured to check whether the kernel of the executed task is terminated again when the executed task is not executed in the extra memory, or the higher-priority is not terminated.
